(19) United States
(12) Patent Application Publication
(10) Pub. No.: US 2024/0220208 A1
(43) Pub. Date: Jul. 4, 2024

(54) Induced Signal Marginality for Random Number Generation

(71) Applicant: Advanced Micro Devices, Inc., Santa Clara, CA (US)

(72) Inventors: Jerry Anton Ahrens, Sister Bay, WI (US); William Robert Alverson, Del Valle, TX (US); Amitabh Mehra, Fort Collins, CO (US); Grant Evan Ley, Eden, UT (US); Joshua Taylor Knight, Georgetown, TX (US); Anil Harwani, Austin, TX (US); Jayesh Hari Joshi, Austin, TX (US)

(73) Assignee: Advanced Micro Devices, Inc., Santa Clara, CA (US)

(21) Appl. No.: 18/147,257

(22) Filed: Dec. 28, 2022

(51) Int. Cl. G06F 7/58

(52) U.S. Cl. CPC G06F 7/588

(57) ABSTRACT

Induced signal marginality for random number generation is described. In accordance with the described techniques, a pseudorandom number is transmitted across an interface while the interface is operated with settings configured to cause instability in the interface. A random number is received as an output of the interface. The settings configured to cause instability in the interface include overclocked settings of interface operating parameters.

### BACKGROUND

Random numbers are used in a variety of applications, such as simulations, electronic gaming, and cryptography. For example, random numbers are used for securing software and transmissions by preventing reverse engineering of pseudorandom code. Most computer-implemented random number generators produce sequences of pseudorandom numbers, whose properties approximate those of random numbers but are not truly random.

### BRIEF DESCRIPTION OF THE DRAWINGS

FIG. 1 is a block diagram of a non-limiting example system having an interface operable to implement overclocking-induced random number generation.

FIG. 2 depicts a non-limiting example in which settings for random number generation settings are learned during training.

FIG. 3 depicts a non-limiting example of an operating parameter of an interface.

FIG. 4 shows a non-limiting example of varying an operating parameter of an interface within an operating range during random number generation.

FIG. 5 depicts a procedure in an example implementation of a training process for random number generation via interface overclocking.

FIG. 6 depicts a procedure in an example implementation of generating random numbers by inducing signal marginality in an interface.

### DETAILED DESCRIPTION

### Overview

Pseudorandom numbers are mathematically determined, such as via an algorithm of a pseudorandom number generator. While pseudorandom numbers approximate truly random numbers, their randomness is limited by the algorithm that generates them, the inputs and/or outputs of which can be monitored to determine how the pseudorandom numbers are produced by the algorithm and subsequently to predict the pseudorandom numbers. Because random numbers are often used for securing software and communications (e.g., cryptography), creating unpredictable, truly random numbers increases security.

To solve these problems, induced signal marginality for random number generation is described. In accordance with the described techniques, an interface is operated with random number generation settings that are configured to induce signal marginality in the interface. For instance, at least one component that is part of the interface is operated with a setting (e.g., an overclocked setting) that causes signal marginality to be induced in the interface. Some interfaces can be “overclocked” by modifying specific interface parameters (e.g., of components of the interface) in order to achieve, for example, faster operating speeds. Signal marginality occurs when at least one component of the interface is overclocked beyond stable data transmission settings, such that the data transmission approaches transmission failure. The interface parameters include, for example, voltage parameters, frequency parameters, temperature parameters, and timing parameters. A controller performs a training process to learn operating ranges of the interface parameters where errors, such as bit flips, reliably occur in data transmitted across the interface (e.g., due to the signal marginality). The controller stores these learned operating ranges as the random number generation settings.

A random number is generated by transmitting a pseudorandom number across the interface while the interface is operated (e.g., by the controller) with the random number generation settings. Although the pseudorandom number is generated via an algorithm, the stochastic nature of the errors introduced by the signal marginality of the interface generates a truly random number from the pseudorandom number. The random number is non-algorithmic and is not able to be reverse engineered. As a result, a security of an application using the random number is increased.

In one or more implementations, operating the interface with the random number generation settings includes dynamically adjusting at least one interface parameter within its operating range. For example, the at least one interface parameter is pseudo-randomly varied so that the parameters inducing the signal marginality are themselves difficult to predict. By varying the causes of the signal marginality in the interface, a likelihood that the random number is predicted or reverse engineered is further decreased.

In various scenarios, the interface is an off-the-shelf, commercially available component. Non-limiting examples of the interface include a peripheral component interconnect express (PCIe) link, a double data rate (DDR) interface, or a global memory interconnect (GMI) link. In such scenarios, the random numbers are generated using existing hardware that has undergone the training process to identify the random number generation settings. By repurposing existing hardware as a random number generating system, a cost of the random number generating system is decreased. Moreover, an availability of the random number generating system is increased.

A technical effect of inducing signal marginality in an interface via at least one overclocked setting while transmitting a pseudorandom number across the interface is that unpredictable errors occur in the pseudorandom number during transmission, resulting in a truly random number being generated by the interface.

In some aspects, the techniques described herein relate to a system including: an interface, and a controller configured to: receive a pseudorandom number, transmit the pseudorandom number across the interface while operating the interface with settings configured to cause instability in the interface, and receive a random number as an output of the interface.

In some aspects, the techniques described herein relate to a system, wherein the settings configured to cause instability in the interface include overclocked settings of one or more interface operating parameters.

In some aspects, the techniques described herein relate to a system, wherein transmitting the pseudorandom number across the interface includes transmitting the pseudorandom number from a first endpoint of the interface to a second endpoint of the interface.

In some aspects, the techniques described herein relate to a system, wherein the random number is generated from the pseudorandom number via errors introduced in the pseudorandom number.

In some aspects, the techniques described herein relate to a system, wherein the controller is further configured to learn the settings configured to cause the instability in the interface during a training process.

In some aspects, the techniques described herein relate to a system, wherein the training process includes identifying, via the controller, a margin range of an interface operating parameter.

In some aspects, the techniques described herein relate to a system, wherein the margin range of the interface operating parameter is bounded by a margin threshold where errors begin in data transmission across the interface and a failure threshold where the data transmission across the interface does not occur.

In some aspects, the techniques described herein relate to a system, wherein the training process further includes setting, via the controller, a subset of the margin range as the settings configured to cause the instability in the interface for the interface operating parameter.

In some aspects, the techniques described herein relate to a system, wherein operating the interface with the settings configured to cause instability in the interface includes dynamically adjusting the interface operating parameter within the subset of the margin range.

In some aspects, the techniques described herein relate to a method including: transmitting a pseudorandom number across an interface while operating an interface with overclocked settings configured to induce data transmission errors, and receiving a random number as an output of the interface while operating the interface with the overclocked settings.

In some aspects, the techniques described herein relate to a method, wherein the random number is generated from the pseudorandom number by inducing random errors in the pseudorandom number by operating the interface with the overclocked settings.

In some aspects, the techniques described herein relate to a method, further including learning the overclocked settings during a training process that includes monitoring for the data transmission errors while iteratively adjusting one or more operating parameters of the interface.

In some aspects, the techniques described herein relate to a method, wherein the one or more operating parameters of the interface include voltage, temperature, frequency, and timing settings of the interface.

In some aspects, the techniques described herein relate to a method, wherein the training process further includes: establishing a first threshold of a margin range for an operating parameter of the interface based on a first occurrence of the data transmission errors while iteratively adjusting the operating parameter, establishing a second threshold of the margin range based on data transmission failure of the interface while iteratively adjusting the operating parameter, and setting a random number generation operating range for the operating parameter within the margin range, between the first threshold and the second threshold.

In some aspects, the techniques described herein relate to a method, wherein the operating the interface with the overclocked settings includes controlling the operating parameter to be within the random number generation operating range.

In some aspects, the techniques described herein relate to a method, wherein the controlling the operating parameter to be within the random number generation operating range includes varying the operating parameter within the random number generation operating range.

In some aspects, the techniques described herein relate to an apparatus, including: an interface, and a controller configured to: generate a random number from a pseudorandom number by transmitting the pseudorandom number across the interface while operating the interface with settings configured to introduce random errors in the pseudorandom number.

In some aspects, the techniques described herein relate to an apparatus, wherein the controller is further configured to learn the settings during a training process that includes identifying margin ranges of interface operating parameters based on data transmission errors that occur while shmooing the interface operating parameters.

In some aspects, the techniques described herein relate to an apparatus, wherein the pseudorandom number is generated via a pseudorandom number generation algorithm.

In some aspects, the techniques described herein relate to an apparatus, wherein the settings are configured to introduce random errors in the pseudorandom number via one or more of bit flips, cross talk, and read marginality.

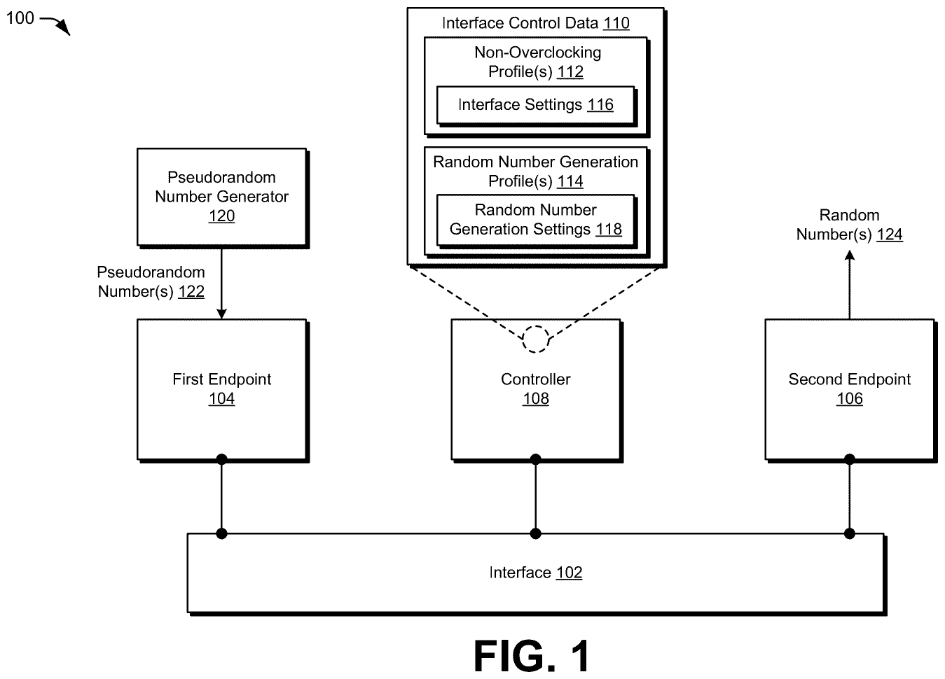

FIG. 1 is a block diagram of a non-limiting example system 100 having an interface operable to implement overclocking-induced random number generation. In particular, the system 100 includes an interface 102, a first endpoint 104, a second endpoint 106, and a controller 108. In accordance with the described techniques, the interface 102 provides a wired connection between the first endpoint 104 and the second endpoint 106. Example wired connections include, but are not limited to, buses (e.g., a data bus), interconnects, through-silicon vias, traces, and planes. Examples of the interface 102 include, but are not limited to, a peripheral component interconnect express (PCIe) link, a double data rate (DDR) interface, or a global memory interconnect (GMI) link. Alternatively, the interface 102 is another type of data transmission fabric or interconnect. The interface 102 includes, is formed of, or is otherwise associated with one or more components that are operated with settings that can be adjusted to operate outside of stock (nominal) parameters (e.g., overclocked) by the controller 108 to cause instability across the interface 102.

The first endpoint 104 and the second endpoint 106 communicate across the interface 102. In at least one implementation, one or both of the first endpoint 104 and the second endpoint 106 is a device or system that is used to store information, such as for immediate use in a device. In one or more implementations, the first endpoint 104 and/or the second endpoint 106 corresponds to semiconductor memory where data is stored within memory cells on one or more integrated circuits. In at least one example, the first endpoint 104 and/or the second endpoint 106 corresponds to or includes volatile memory, examples of which include random-access memory (RAM), dynamic random-access memory (DRAM), and static random-access memory (SRAM). Alternatively or in addition, the first endpoint 104 and/or the second endpoint 106 corresponds to or includes non-volatile memory, examples of which include flash memory, read-only memory (ROM), programmable read-only memory (PROM), erasable programmable read-only memory (EPROM), electronically erasable programmable read-only memory (EEPROM), and non-volatile memory (e.g., NVDIMM).

In one or more implementations, the first endpoint 104 and/or the second endpoint 106 is configured as a dual in-line memory module (DIMM). A DIMM includes a series of dynamic random-access memory integrated circuits, and the modules are mounted on a printed circuit board. Examples of types of DIMMs include, but are not limited to, synchronous dynamic random-access memory (SDRAM), double data rate (DDR) SDRAM, double data rate 2 (DDR2) SDRAM, double data rate 3 (DDR3) SDRAM, double data rate 4 (DDR4) SDRAM, and double data rate 5 (DDR5) SDRAM. In at least one variation, the first endpoint 104 and/or the second endpoint 106 is configured as a small outline DIMM (SO-DIMM) according to one of the above-mentioned SDRAM standards, e.g., DDR, DDR2, DDR3, DDR4, and DDR5. In one or more implementations, the first endpoint 104 is low-power double data rate (LPDDR), also known as LPDDR SDRAM, and is a type of synchronous dynamic random-access memory. In variations, LPDDR consumes less power than other types of memory and/or has a form factor suitable for mobile computers and devices, such as mobile phones. Examples of LPDDR include, but are not limited to, low-power double data rate 2 (LPDDR2), low-power double data rate 3 (LPDDR3), low-power double data rate 4 (LPDDR4), and low-power double data rate 5 (LPDDR5).

In at least one implementation, one or both of the first endpoint 104 and the second endpoint 106 is a device or system that is used to perform operations on data. In at least one example, the first endpoint 104 and/or the second endpoint 106 corresponds to or includes a processor or a processor core, examples of which include, but are not limited to, a central processing unit, a parallel accelerated processor (e.g., a graphics processing unit), a digital signal processor, a hardware accelerator, a microcontroller, and a system-on-chip. It is to be appreciated that the first endpoint 104 and the second endpoint 106 are configurable in a variety of ways without departing from the spirit or scope of the described techniques.

The controller 108 manages the interface 102, including the communication of data via the interface 102. For example, the controller 108 manages the communication of data from the first endpoint 104 to the second endpoint 106 and the communication of data from the second endpoint 106 to the first endpoint 104, e.g., over the interface 102. In an example implementation, the second endpoint 106 is a component that requests access to data from the first endpoint 104 for performing one or more operations in relation to such data, such as in connection with executing an application (not shown). As discussed herein, the controller 108 also determines and adjusts settings (e.g., clock and/or power settings) according to which the interface 102 is or can be configured to operate. In at least one variation, such settings are specified in interface control data 110.

In the illustrated example, the controller 108 is depicted having the interface control data 110, which in this example include one or more non-overclocking profiles 112 and one or more random number generation profiles 114. The random number generation profiles 114 utilize overclocking of the interface 102 to induce signal marginality. The non-overclocking profiles 112 are implemented using interface settings 116, whereas the random number generation profiles 114 are implemented using one or more random number generation settings 118. The one or more random number generation settings 118 are configured to induce signal marginality in the interface 102 such that random errors are introduced during data transmission across the interface 102.

In accordance with the described techniques, the random number generation settings 118 include at least one interface setting that is overclocked. In one or more scenarios, not all interface settings of a particular random number generation profile 114 are overclocked. In other scenarios, however, all of the interface settings of a random number generation profile 114 are overclocked. In one or more implementations, an interface setting that is “overclocked” exceeds a certified value of the setting. For example, a clock rate that is set to exceed the clock rate certified by a manufacturer of the interface 102 is “overclocked.” By contrast, an interface setting that is not “overclocked” does not exceed the certified value of the setting. For example, a clock rate that is not “overclocked” does not exceed the clock rate certified by the manufacturer of the interface 102. Broadly, use of the random number generation settings 118 and/or the random number generation profiles 114 enables the interface 102 to operate in an overclocking mode that intentionally induces data transmission errors.

In at least one implementation, the system 100 further includes a pseudorandom number generator 120 that is configured to output one or more pseudorandom numbers 122. By way of example, the pseudorandom number generator 120 executes an algorithm to produce the one or more pseudorandom numbers 122. The one or more pseudorandom numbers 122 are pseudorandom binary sequences, for example, of a same or varying length. In one or more implementations, the pseudorandom number generator 120 is or is included in a platform security processor (PSP). Although the pseudorandom number generator 120 is illustrated as a separate component from the first endpoint 104, it is to be appreciated that in variations, the pseudorandom number generator 120 is, or is included in, the first endpoint 104. By way of example, the first endpoint 104 is a PSP that executes a pseudorandom number generation algorithm.

As discussed above, the pseudorandom numbers 122 approximate random numbers but are not truly random. Thus, in accordance with the techniques described herein, operating the interface 102 with the random number generation profiles 114 enables output of one or more random numbers 124 (e.g., truly random numbers) from the second endpoint 106. That is, to generate the one or more random numbers 124, the pseudorandom number(s) 122 generated by the pseudorandom number generator 120 are transmitted through the interface 102, from the first endpoint 104 to the second endpoint 106, while the random number generation settings 118 are in use. For instance, at least one component that is part of the interface is operated with at least one setting (e.g., an overclocked setting included in the random number generation settings 118) that causes instability in data transmission across the interface 102. As further elaborated herein, the random number generation settings 118 are configured to induce stochastic errors in the data transmission across the interface 102, such as “bit flips” where a ‘1’ in the pseudorandom number 122 is switched to a ‘0’ during the transmission, and vice versa. By operating the interface 102 with the random number generation settings 118, random errors are introduced in the pseudorandom number(s) 122 to produce the one or more random numbers 124.

In accordance with the described techniques, the controller 108 and/or another component of the system 100 (e.g., a physical layer (PHY)) is configured to determine settings for operating the interface 102, such as testing a stability of the interface settings 116 of one or more non-overclocking profiles 112 and/or learn the random number generation settings 118 of one or more random number generation profiles 114. In at least one variation, the controller 108 implements a training process to determine the random number generation settings 118 (e.g., for one or more of the random number generation profiles 114) for operating the system 100 to produce the one or more random numbers 124.

Examples of the one or more operations the controller 108 and/or other component perform on the interface 102 during the training process include, but are not limited to, performing frequency, voltage, timing, and temperature adjustments. For example, one or more shmoos of the interface pertinent frequency, interface voltage, and temperatures of the first endpoint 104 and the second endpoint 106 are generated to establish operating points for each where errors (e.g., bit flips, cross talk, marginality of reads) begin and where the interface 102 loses functionality. As used herein, a “shmoo” refers to a plot or the act of generating a plot that indicates the results of testing one or more components of the system, e.g., a shmoo indicates a response of the component when conditions with which the component operates are varied. In at least one implementation, the controller 108 performs reference voltage (Vref) shmoos, delay-locked loop (DLL) shmoos, virtual timing and signal analysis (vTSA) tests, and/or different voltage and delay level adjustments to the first endpoint 104 and the second endpoint 106 to adjust the operating parameters of the interface 102. Additionally or alternatively, the controller 108 performs at least one of the Vref shmoos, DLL shmoos, vTSA tests, and voltage/delay level adjustments directly on the interface 102. In one or more implementations, the controller 108 generates one or more eye diagrams of the interface 102 operating parameters using a combination (e.g., a multidimensional combination) of Vref and DLL shmoos. Based on the generated eye diagrams, for instance, the controller 108 obtains the margins at which the interface 102 is capable of performing. In variations, different tests are performed to identify the margins of the interface 102 without departing from the described techniques.

In one or more implementations, the interface settings 116 and the random number generation settings 118 include various clock and/or power settings. Example settings include, but are not limited to, a data rate (e.g., megatransfers per second), a number of cycles between sending a data pattern from the first endpoint 104 to the second endpoint 106, a nominal power supply voltage (e.g., VDD), output stage drain power voltage (e.g., VDDQ), and programming power voltage (e.g., VPP). It is to be appreciated that the interface settings 116 and/or the random number generation settings 118 specify values for one or more of those settings and/or various other settings associated with operating the interface 102 without departing from the spirit or scope of the described techniques.

In accordance with the described techniques, the controller 108 and/or another component is configured to set the clock and power inputs to cause the interface 102 to operate according to a set of interface settings, such as an interface profile. For instance, the clock and power inputs cause the interface 102 to operate according to one of the non-overclocking profiles 112 implemented using a set of the interface settings 116 or one of the random number generation profiles 114 implemented using a set of the random number generation settings 118.

For example, the controller 108 causes the interface 102 to operate according to a set of the interface settings 116 or a set of the random number generation settings 118 by sending one or more change signals to a voltage generator (not shown) to adjust a supply voltage (e.g., VDD), such that the clock and power inputs subsequently include the supply voltage as adjusted according to the change signals. Additionally or alternatively, the controller 108 sends a change signal to a reference clock generator (not shown) to change a frequency of a clock rate, such that the clock and power inputs subsequently include a reference clock signal as adjusted according to the change signals. The controller 108 is operable to adjust the clock and power inputs in various ways to produce the settings specified, e.g., in a given profile of the interface control data 110, for operating the interface 102.

Examples of a device or apparatus in which the system 100 is configured for integration include, but are not limited to, servers, personal computers, laptops, desktops, game consoles, set top boxes, tablets, smartphones, mobile devices, virtual and/or augmented reality devices, wearables, medical devices, systems-on-chips, and other computing devices or systems.

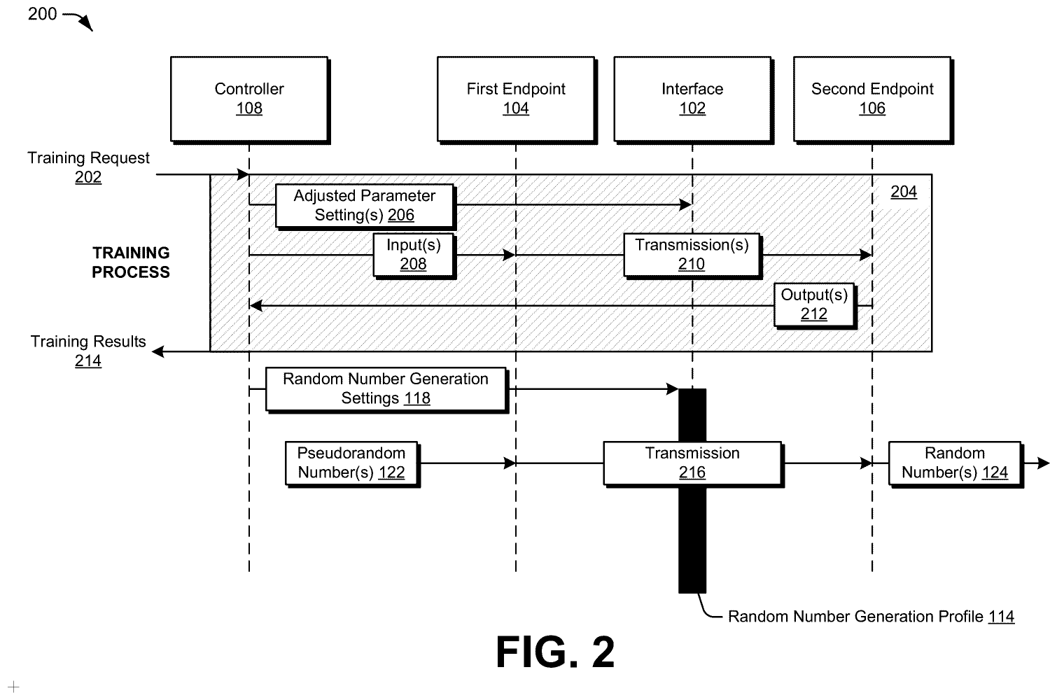

FIG. 2 depicts a non-limiting example 200 in which training is performed to learn settings for random number generation by an interface. The example 200 includes the interface 102, the first endpoint 104, the second endpoint 106, and the controller 108 from FIG. 1.

The example 200 includes a variety of example communications and operations between the controller 108, the interface 102, the first endpoint 104, and the second endpoint 106 over time. In this example 200, the communications and operations are positioned vertically based on time, such that communications and operations closer to a top of the example occur prior to communications or operations farther from the top of the example. It follows also that communications or operations closer to a bottom of the example occur subsequent to communications or operations farther from the bottom. The example 200 also depicts various phases and/or states of the system 100 or portions of the system 100. These phases and/or states are also positioned in the example 200 vertically based on time, such that phases or states closer to a top of the example occur prior to phases, states, or communications farther from the top.

Here, the illustrated example 200 depicts the controller 108 receiving a training request 202. In one or more implementations, the training request 202 is received based on user input, such as user input received via a displayed control to learn settings for random number generation by overclocking parameters of the interface. For instance, user input is received via the displayed control to learn one or more sets of the random number generation settings 118 (e.g., of one or more random number generation profiles 114). In at least one variation, the training request 202 is received responsive to an indication that random number generation is desired when random number generation profiles 114 are not yet determined. The illustrated example 200 also depicts a training process 204 of the system 100. In one or more implementations, the system 100 enters the training process 204 responsive to receiving the training request 202.

In accordance with the described techniques, the training process 204 includes monitoring data transmission through the interface 102 while adjusting interface operating parameters. For instance, the controller 108 tests a stability of data transmission through the interface 102 while operating the interface 102 with one or more adjusted parameter settings 206. As part of the training process 204, in one or more implementations, the controller 108 performs frequency, voltage, timing, and temperature shmoos of the interface 102, with the interface operating parameters adjusted alone or in combination, while sending one or more inputs 208 from the first endpoint 104 to the second endpoint 106 via the interface 102, represented in the example 200 as transmission(s) 210.

Based on one or more outputs 212 at the second endpoint 106, for example, the controller 108 obtains the margins at which the interface 102 is capable of operating with and without errors in the data transmission and at which transmission through the interface 102 ceases. That is, the controller 108 compares the output 212 to the corresponding input 208 to determine if errors (such as bit flips, cross talk, and marginality of reads) have occurred during the transmission 210 through the interface 102. In at least one implementation, the training process 204 includes monitoring for errors by comparing the one or more outputs 212 to the one or more inputs 208 while performing iterative adjustments to at least one operating parameter of the interface 102. Furthermore, the interface 102 is operated without error correction in order to identify the margins for operating without errors and where transmission through the interface 102 fails for a given interface operating parameter. Alternatively, the controller 108 identifies error corrections and retries that occur on the interface 102 while operating with error correction.

In one or more implementations, the controller 108 determines the training results 214 based on the one or more outputs 212 received from the second endpoint 106 during the training process 204. Broadly, the training results 214 indicate operating points where errors or bit flips first (e.g., initially) occur during the transmissions 210 (e.g., a margin threshold) and where the transmissions 210 fail (e.g., a failure threshold where no outputs 212 first occur). The controller 108 uses the training results 214 to determine the random number generation settings 118, e.g., a set of the random number generation settings 118. In at least one implementation, the random number generation settings 118 include, for one or more operating parameters of the interface 102, an operating range that is between the margin threshold and the failure threshold for that operating parameter.

Subsequent to the training process 204, the controller 108 provides the random number generation settings 118 to the interface 102 (and/or the first endpoint 104 and the second endpoint 106) to cause the interface 102 to operate according to one of the random number generation profiles 114. In accordance with the described techniques, the controller 108 causes the interface 102 to operate according to the random number generation profile 114 so that random errors occur in pseudorandom numbers 122 input into the first endpoint 104 during transmission 216 through the interface 102, resulting in random numbers 124 being output at the second endpoint 106.

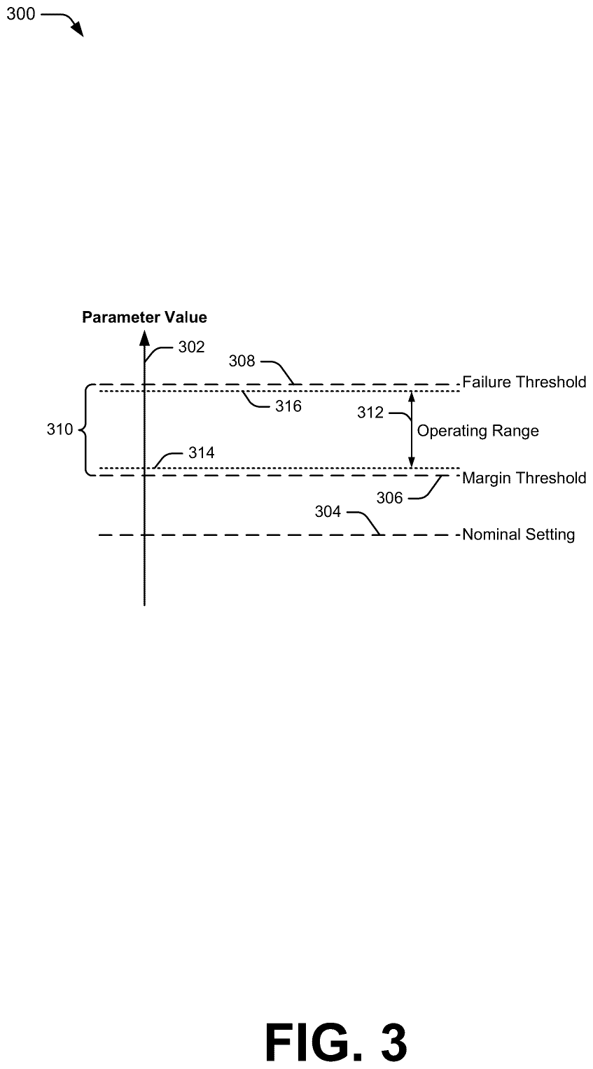

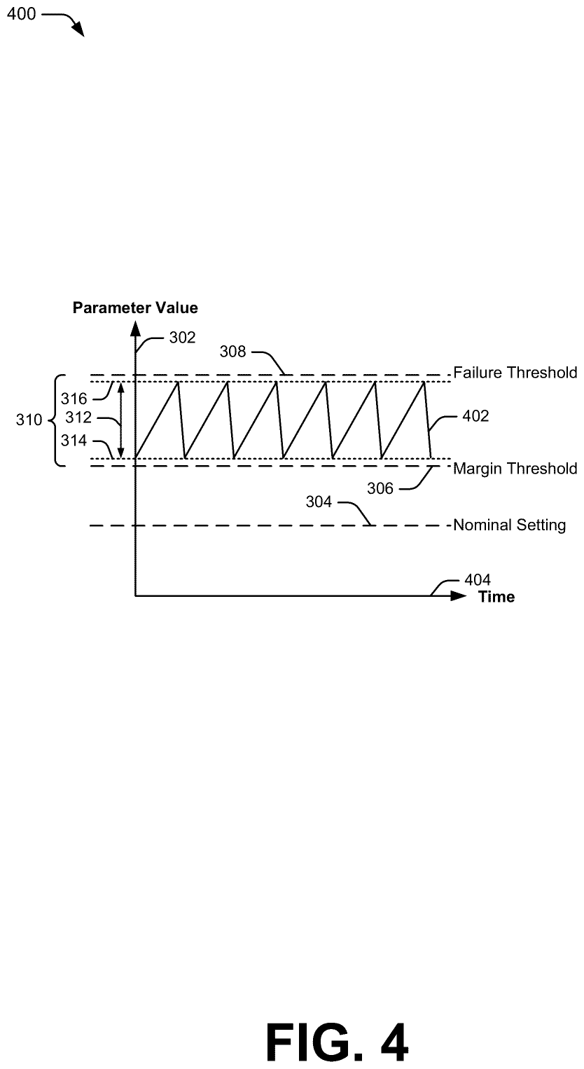

In the context of determining operating ranges for signal marginality-induced random number generation, consider the following discussion of FIGS. 3 and 4.

FIG. 3 depicts a non-limiting example 300 of an operating parameter of the interface 102 of FIG. 1. The operating parameter represents temperature, voltage, frequency, or timing, for example, of the interface 102, the first endpoint 104 and/or the second endpoint 106. The example 300 includes a vertical axis 302, which indicates that a value of the operating parameter increases from bottom to top (e.g., in the direction of the arrow). The example 300 further includes a nominal setting 304, a margin threshold 306, and a failure threshold 308. The nominal setting 304 represents, for example, an interface setting 116 of the one or more non-overclocking profiles 112 that is used when random number generation is not desired. The margin threshold 306 represents an initial operating point where errors, such as bit flips, occur during data transmission through the interface 102 (e.g., as determined by comparing each output 212 to the corresponding input 208 of FIG. 2), and the failure threshold 308 represents an operating point where data transmission through the interface 102 no longer occurs (e.g., a first occurrence where no output 212 is received at the second endpoint 106).

In the depicted example 300, increasing the value of the operating parameter decreases a stability of the data transmission. As such, the margin threshold 306 is greater than the nominal setting 304, and the failure threshold 308 is greater than the margin threshold 306. However, it is to be appreciated that in other examples, decreasing the value of the operating parameter decreases the stability of the data transmission. Thus, in at least one variation, the nominal setting 304 is greater than the margin threshold 306, and the margin threshold 306 is greater than the failure threshold 308.

A margin range 310 includes a range of values between the margin threshold 306 and the failure threshold 308. The margin range 310 refers to an operating range of the operating parameter where function of the interface 102 is marginal. Due to this marginality, random errors occur in data transmission via the interface 102. In at least one implementation, an operating range 312 for the random number generation settings 118 is defined as a subset of the margin range 310. In the depicted example 300, the operating range 312 includes values between a lower threshold 314 that is greater than the margin threshold 306 and an upper threshold 316 that is less than the failure threshold 308. By including a subset of the margin range 310 in the operating range 312, a likelihood that random errors will occur without data transmission failure is increased. In contrast, including the failure threshold 308 in the operating range 312 increases a likelihood that data transmission failure occurs, and including the margin threshold 306 decreases random error generation by the interface 102. Thus, including a subset of the margin range 310 in the operating range 312 increases a quality of the random number generation.

In at least one implementation, one or more of the random number generation profiles 114 includes a single set value (e.g., in the random number generation settings 118) for the operating parameter. Additionally or alternatively, at least one of the random number generation profiles 114 includes instructions for varying the operating parameter within the operating range 312 while operating the interface 102 to generate random numbers, as will be elaborated below.

FIG. 4 shows a non-limiting example 400 of varying the operating parameter within an operating range during random number generation. In addition to the elements depicted in FIG. 3, the non-limiting example 400 further includes a parameter value plot 402 that depicts the value of the operating parameter being varied across time, which is represented by a horizontal axis 404. In the depicted non-limiting example 400, the parameter value plot 402 oscillates within the operating range 312 in a sawtooth pattern. However, it is to be appreciated that the shape of the parameter value plot 402 is provided for illustration, and not limitation. For example, in variations, the parameter value plot 402 is a sine wave, a square wave, another type of periodic wave, or is not periodic. In some variations, the parameter value plot 402 includes regular or irregular adjustments that are continuous or stepwise. Thus, the parameter value plot 402 is shaped in a variety of ways without departing from the spirit or scope of the described techniques.

In the non-limiting example 400, the parameter value is varied within the operating range 312 while the interface 102 is operated with one of the random number generation profiles 114. In at least one implementation, the parameter value is varied within the operating range 312 based on instructions included in the random number generation profiles 114. In some examples, the instructions include pseudo-randomly varying the parameter value within the operating range 312. By combining the signal integrity-introduced random errors in the transmitted pseudorandom numbers 122 with the pseudorandom variation of the parameter value (e.g., changes to voltage, frequency, and/or temperature of the interface 102), a likelihood that transmission over the interface 102 produces truly random and non-deterministic numbers is increased. For example, it is more difficult to reverse-engineer the numbers output by the interface 102 when values of one or more of the operating parameters are varied. In this way, the interface 102 is operated to produce one or more random numbers 124 from the one or more pseudorandom numbers 122.

Having discussed example systems and for random number generation by interface overclocking, consider the following example procedures.

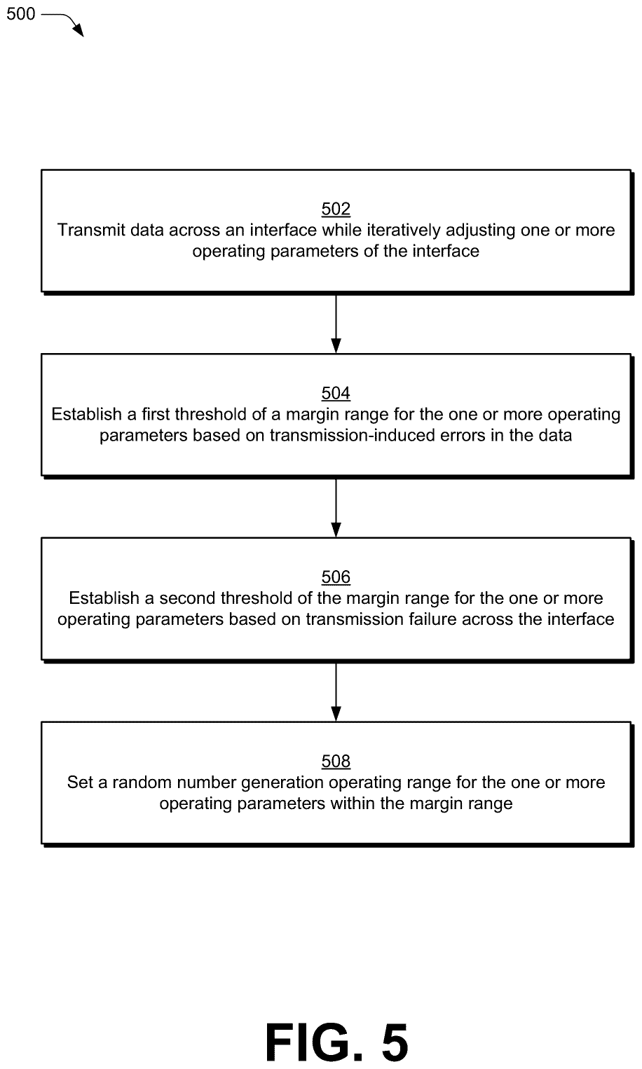

FIG. 5 depicts a procedure 500 in an example implementation of a training process for random number generation via interface overclocking.

Data is transmitted across an interface while one or more operating parameters of the interface are iteratively adjusted (block 502). By way of example, controller 108 and/or another component of the system 100 (e.g., physical layer (PHY)) are configured to identify random number generation settings 118 for operating the interface 102 according to one or more random number generation profiles 114. In at least one variation, the controller 108 tests a stability of data transmission for one or more interface operating parameter, including, e.g., voltage, temperature, frequency, and timing parameters, in order to identify operating margins. For example, for each round of the training process, the controller 108 adjusts (e.g., changes a value of) least one of the interface operating parameters, transmits data across the interface, and compares an output of the interface to the input data to identify whether the adjustment(s) resulted in transmission-induced errors in the data or data transmission failure. As a non-limiting example, the controller 108 begins at the nominal setting 304 of an operating parameter and incrementally changes (e.g., increases) the value of the operating parameter during each round of the training process while monitoring for transmission-induced errors in the data.

A first threshold of a margin range for the one or more operating parameters is established based on transmission-induced errors in the data (block 504). By way of example, the controller 108 sets the first threshold for the margin range (e.g., the margin threshold 306 of the margin range 310) as the parameter value at which errors are initially observed in the output of the interface compared with the input data. In at least one implementation, the first threshold of the margin range of at least one operating parameter varies based on values of the other operating parameters, such as when adjustments to multiple operating parameters have a synergistic effect on signal marginality. Alternatively, the first threshold of the margin range of each operating parameter is independent of the values of the other operating parameters.

A second threshold of the margin range for the one or more operating parameters is established based on transmission failure across the interface (block 506). By way of example, the controller 108 sets the second threshold for the margin range (e.g., the failure threshold 308 of the margin range 310) as the parameter value at which the controller 108 does not receive an output from the interface 102 when data is input. In at least one implementation, the second threshold of the margin range of at least one operating parameter varies based on values of the other operating parameters, such as when adjustments to multiple operating parameters have a synergistic effect on data transmission failure. Alternatively, the second threshold of the margin range of each operating parameter is independent of the values of the other operating parameters. Together, the first threshold and the second threshold define the bounds of the margin range. For example, the interface 102 transmits data without errors or does not function to transmit data when operating with settings outside of the margin range.

A random number generation operating range is set for the one or more operating parameters within the margin range (block 508). By way of example, the controller 108 sets the random number generation operating range (e.g., the operating range 312) to be a subset of the margin range. As a non-limiting example, a lower threshold of the random number generation operating range (e.g., the lower threshold 314) is set to be a fixed value or percentage greater than the first threshold of the margin range, and an upper threshold of the random number generation operating range (e.g., the upper threshold 316) is set to be a same or different fixed value or percentage less than the second threshold of the margin range. In variations, the random number generation operating range includes all of the margin range.

It is to be appreciated that separate margin ranges and random number generation operating ranges are determined for each of the one or more operating parameters, at least in one implementation.

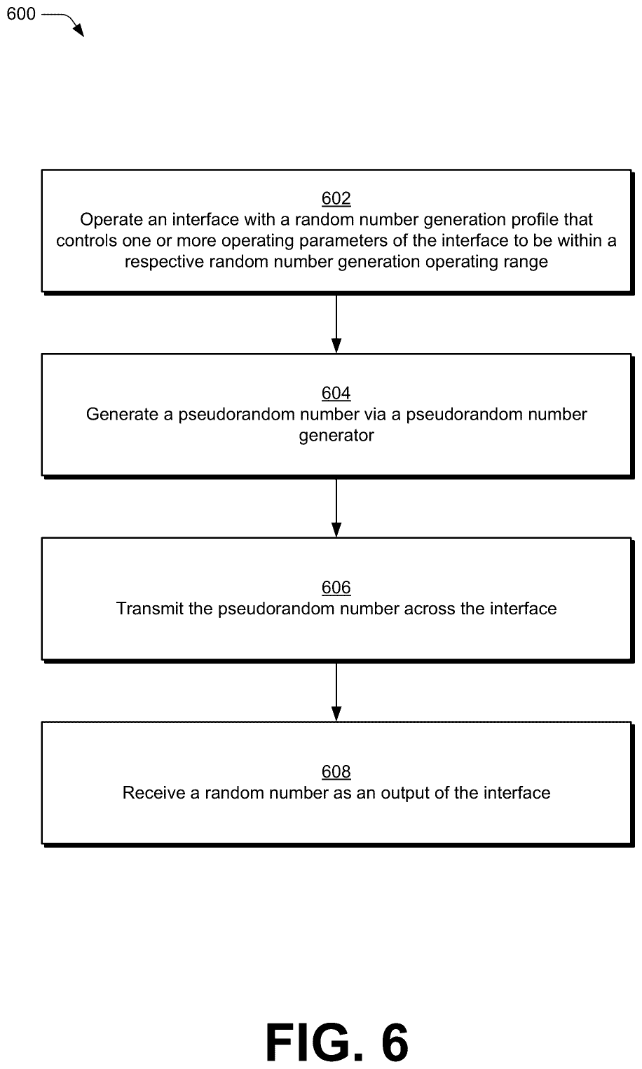

FIG. 6 depicts a procedure 600 in an example implementation of generating random numbers by inducing signal marginality in an interface.

The interface is operated with a random number generation profile that controls one or more operating parameters of the interface to be within a respective random number generation operating range (block 602). By way of example, the random number generation profile 114 includes single values for the one or more operating parameters and/or includes instructions for dynamically adjusting the one or more operating parameters while operating the interface 102. As elaborated herein, the random number generation operating range includes at least a portion of a margin range for the respective operating parameter, as identified (e.g., by the controller 108) during the training process 204. Furthermore, the random number generation profile 114 disables error correction on the interface 102. Operating the interface 102 with the random number generation profile 114 introduces random errors in data transmitted through the interface 102 due to, for example, bit flips, cross talk, and marginal reads.

A pseudorandom number is generated via a pseudorandom number generator (block 604). By way of example, the pseudorandom number generator 120 generates the one or more pseudorandom numbers 122 via an algorithm. In one or more implementations, the pseudorandom number generator 120 is included in a PSP.

The pseudorandom number is transmitted across the interface (block 606). By way of example, each pseudorandom number 122 generated by the pseudorandom number generator 120 is input at the first endpoint 104 of the interface 102 and is transmitted through the interface 102 to the second endpoint 106 of the interface 102.

A random number is received as an output of the interface (block 608). By way of example, the second endpoint 106 outputs the random number 124, which has random errors that distinguish it from the input pseudorandom number 122. Due to the stochastic nature of the errors introduced by the signal marginality of interface 102, the generation of the random number 124 is non-algorithmic and non-repeatable, thus increasing a security of software or transmissions using the one or more random numbers 124, for example.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the interface 102, the first endpoint 104, second endpoint 106, and the controller 108) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system comprising:
an interface; and
a controller configured to:
receive a pseudorandom number;
transmit the pseudorandom number across the interface while operating the interface with settings configured to cause instability in the interface; and
receive a random number as an output of the interface.

2. The system of claim 1, wherein the settings configured to cause instability in the interface include overclocked settings of one or more interface operating parameters.

3. The system of claim 1, wherein transmitting the pseudorandom number across the interface comprises transmitting the pseudorandom number from a first endpoint of the interface to a second endpoint of the interface.

4. The system of claim 1, wherein the random number is generated from the pseudorandom number via errors introduced in the pseudorandom number.

5. The system of claim 1, wherein the controller is further configured to learn the settings configured to cause the instability in the interface during a training process.

6. The system of claim 5, wherein the training process includes identifying, via the controller, a margin range of an interface operating parameter.

7. The system of claim 6, wherein the margin range of the interface operating parameter is bounded by a margin threshold where errors begin in data transmission across the interface and a failure threshold where the data transmission across the interface does not occur.

8. The system of claim 6, wherein the training process further includes setting, via the controller, a subset of the margin range as the settings configured to cause the instability in the interface for the interface operating parameter.

9. The system of claim 8, wherein operating the interface with the settings configured to cause instability in the interface includes dynamically adjusting the interface operating parameter within the subset of the margin range.

10. A method comprising:
transmitting a pseudorandom number across an interface while operating an interface with overclocked settings configured to induce data transmission errors; and
receiving a random number as an output of the interface while operating the interface with the overclocked settings.

11. The method of claim 10, wherein the random number is generated from the pseudorandom number by inducing random errors in the pseudorandom number by operating the interface with the overclocked settings.

12. The method of claim 10, further comprising learning the overclocked settings during a training process that includes monitoring for the data transmission errors while iteratively adjusting one or more operating parameters of the interface.

13. The method of claim 12, wherein the one or more operating parameters of the interface include voltage, temperature, frequency, and timing settings of the interface.

14. The method of claim 12, wherein the training process further comprises:
establishing a first threshold of a margin range for an operating parameter of the interface based on a first occurrence of the data transmission errors while iteratively adjusting the operating parameter;
establishing a second threshold of the margin range based on data transmission failure of the interface while iteratively adjusting the operating parameter; and
setting a random number generation operating range for the operating parameter within the margin range, between the first threshold and the second threshold.

15. The method of claim 14, wherein the operating the interface with the overclocked settings comprises controlling the operating parameter to be within the random number generation operating range.

16. The method of claim 15, wherein the controlling the operating parameter to be within the random number generation operating range comprises varying the operating parameter within the random number generation operating range.

17. An apparatus, comprising:
an interface; and
a controller configured to:
generate a random number from a pseudorandom number by transmitting the pseudorandom number across the interface while operating the interface with settings configured to introduce random errors in the pseudorandom number.

18. The apparatus of claim 17, wherein the controller is further configured to learn the settings during a training process that includes identifying margin ranges of interface operating parameters based on data transmission errors that occur while shmooing the interface operating parameters.

19. The apparatus of claim 17, wherein the pseudorandom number is generated via a pseudorandom number generation algorithm.

20. The apparatus of claim 17, wherein the settings are configured to introduce random errors in the pseudorandom number via one or more of bit flips, cross talk, and read marginality.
